(19) United States
(12) Patent Application Publication
(10) Pub. No.: US 2007/0151140 A1
(43) Pub. Date: Jul. 5, 2007

(54) Safety for mouse trap

(76) Inventors: Jacquelyn R. Crispens, Alton, IL (US); Jack B. Crider SR., Cottage Hills, IL (US)

Correspondence Address: GALASSO & ASSOCIATES, LP, P.O. BOX 2653, AUSTIN, TX, 78755-0503, US

(21) Appl. No.: 11/715,190

(22) Filed: Mar. 7, 2007

Related U.S. Application Data
(63) Continuation of application No. 11/232,832, filed on Sep. 22, 2005.
(60) Provisional application No. 60/613,048, filed on Sep. 27, 2004.

(51) Int. Cl. A01M 23/30

(52) U.S. Cl. 43/81.5; 43/81; 43/96

(57) ABSTRACT

Safety For Mouse Trap is an add-on device for spring-loaded mousetraps or other animal traps. It makes a traditional spring-loaded mousetrap or other animal trap safer. A safety arm located on the device prevents the bow of a traditional mousetrap from accidentally discharging and injuring the user. In the preferred embodiment of the invention, a screw attachment with a collar, safety arm and operating lever is simply screwed into the base of the traditional spring-loaded trap up to the collar of the screw attachment, permitting the safety arm to hang over the bow of the mousetrap. In the event of an accidental discharge, the safety arm will catch the bow and prevent injury to the user. After the mousetrap is set, the user can simply rotate the safety arm with the lever to move the safety arm out of position so it no longer interferes with the recoil of the bow.

### CROSS REFERENCE TO RELATED APPLICATIONS

This Non-Provisional Patent Application is a continuation from U.S. Non-Provisional patent application Ser. No. 11/232,832 entitled “Safety Disposable Mouse Trap” filed on Sep. 22, 2005. That Non-Provisional patent application claimed priority to U.S. Provisional Application Ser. No. 60/613,048 filed on Sep. 22, 2004 entitled “Safety Disposable Mouse Trap.”

### FIELD OF THE DISCLOSURE

The disclosures made herein relate generally to accessories for animal traps. The invention discussed herein is in the general classification of safeties for animal traps.

### BACKGROUND

Rodent removal systems and mousetraps have been utilized for many years to catch, trap, or kill rats and mice in houses and offices. There are many well know types of rodent removal systems. Some of the most common include: spring-loaded traps, poisons, glue trays, electronic traps and even a household pet.

Unfortunately, all of these rodent removal systems have serious drawbacks. Traditional spring-loaded traps are by far the most common type of trap. However, these devices can be unsafe to use because they are difficult to set and can cause injury to the person setting the trap if the bow swings shut inadvertently during the setting process.

Several substitutes to the spring-loaded traps have been invented, but these also have significant disadvantages. For example, glue trays that have a sticky substance coated over plastic or some other material can be used to trap mice or rats. These glue trays can be messy to use and can also inadvertently get caught on a child or household pet, causing the user to have to undertake a laborious cleaning and removal process.

Rat poisons have also been used to kill unwanted rodents. However, the chemicals contained in rat poisons can be dangerous to humans or household pets.

Electronic traps have also been employed to kill rodents. These units emit high voltage shocks to the rodents when they touch metal plates that have been coated with bait. However, these units can also be unsafe to use with children or household pets in the house. Also, because these units have electrical components and require batteries, they can be expensive to operate.

The old-fashioned solution of having a household pet, such as a cat, to catch rodents also has several drawbacks, including the expense and hassle of caring for such a pet.

Because none of the other solutions for trapping rodents have proven more advantageous to the spring-loaded mousetrap, individuals continue to utilize these spring-loaded devices. Hence, there is a need in the art for a convenient to use, safe, effective, durable and cost effective add-on safety device to prevent the bow of traditional spring-loaded mousetraps from harming a user.

### SUMMARY OF THE DISCLOSURE

Safety For Mouse Trap is an add-on device for spring-loaded mousetraps or other animal traps. It makes a traditional spring-loaded mousetrap or other animal trap safer. A safety arm located on the device prevents the bow of a traditional mousetrap from accidentally discharging and injuring the user.

In the preferred embodiment of the invention, a screw attachment with a collar, safety arm and operating lever is simply screwed into the base of the traditional spring-loaded trap up to the collar of the screw attachment, permitting the safety arm to hang over the bow of the mousetrap. In the event of an accidental discharge, the safety arm will catch the bow and prevent injury to the user. After the mousetrap is set, the user can simply rotate the safety arm with the lever to move the safety arm out of position so it no longer interferes with the recoil of the bow.

Although the device described herein is often discussed in conjunction with a mousetrap, it should be understood that such a device could be used on any spring-loaded trap to catch a variety of animals of appropriate size.

The principal object of this invention is to provide an add-on safety device for a spring-loaded mousetrap.

Another object of this invention is to provide a safety device for a spring-loaded mousetrap that can be installed onto the base of conventional spring-loaded mousetraps by a user or manufacturer.

Another object of this invention is to provide an affordable safety device for a spring-loaded mousetrap.

Another object of this invention is to provide an aesthetically pleasing safety device for a spring-loaded mousetrap.

Another object of this invention is to provide a safety device for a spring-loaded mousetrap that is easy to use.

Yet another object of the invention is to provide a lightweight and durable safety device for use with a spring-loaded mousetrap.

### BRIEF DESCRIPTION OF THE DRAWINGS

FIG. 1 depicts a perspective view of the preferred embodiment of the safety device of the present invention.

FIG. 2 depicts a perspective view of the safety device of the present invention attached to a mousetrap.

### DETAILED DESCRIPTION OF THE DRAWINGS

The preferred embodiment of the present invention is comprised of at least some of the following: a threaded screw attachment with a safety arm, collar, and lever that can be placed on traditional spring-loaded mousetraps or other animal traps.

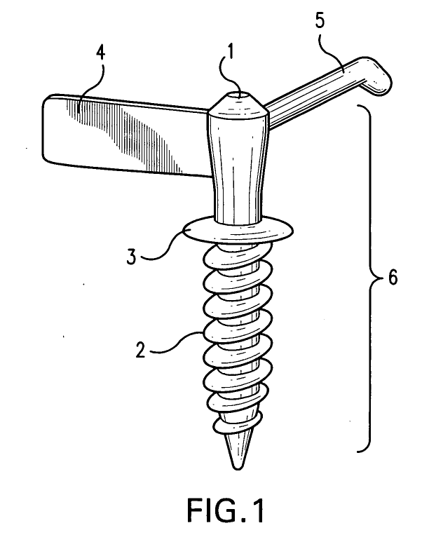

In the preferred embodiment of the safety device 6 for the invention, shown in FIG. 1, a screw attachment 1 has threads 2 extending from approximately the bottom of the screw attachment 1 to the collar 3. The safety device 6 could be made of metal, plastic or a variety of other materials. The distance from the bottom of the screw attachment 1 to the collar 3 may vary widely but is approximately the same as the thickness of the base of a conventional spring-loaded mousetrap in this preferred embodiment. The threads 2 are made of a metal in this preferred embodiment and could be used with traditional wood base mousetraps. If a trap has a harder base, such as metal, a variety of SAE threads could be used. The threads 2 are designed to engage the base of a mousetrap and allow the safety device 6 to be properly anchored to the base of a mousetrap and prevent it from popping free during use. Non-threaded, quick insert type fasteners on the safety device would not provide the necessary anchoring system for use with larger traps or traps having a strong bow recoil. Hence, the threads 2 are critical for reliably attaching the safety device 6 to the base of a mousetrap or other trap.

The collar 3 is circular in this preferred embodiment. The collar 3 is approximately one-half of an inch in diameter though a variety of sizes could be utilized. The collar 3 helps stabilize the safety device 6 against the base of a mousetrap when the threads 2 are screwed into the base of a mousetrap.

A lever 4 is located above the collar 3 and attached to the top portion of the screw attachment 1. A safety arm 5 is also located above the collar 3 and attached to the top portion of the screw attachment 1. The safety arm 5 is angled approximately ninety (90) degrees apart from the lever 4 in the same horizontal plane as the lever 4. The lever 4 can be a variety of sizes and shapes but is one inch in length and approximately rectangular in this preferred embodiment. The safety arm 5 is approximately cylindrical in shape and ranges from one quarter of an inch to one inch in this preferred embodiment. The safety arm 5 has a curved end to help hold the bow of a mousetrap when the safety device 6 is installed on a mousetrap.

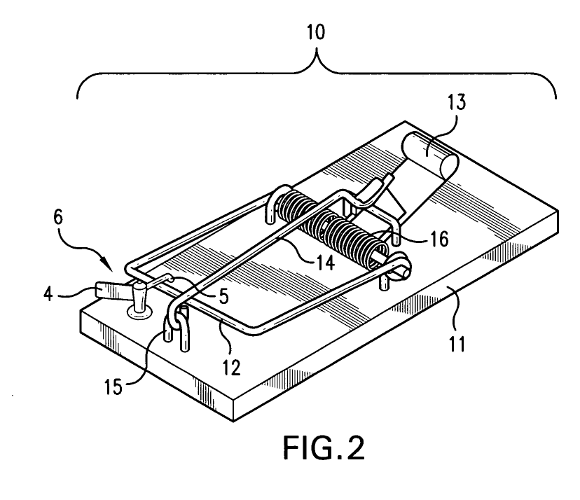

FIG. 2 depicts a perspective view of the safety device of the present invention attached to a mousetrap. The safety device 6 is anchored to the base 11 of a traditional spring-loaded mousetrap 10 at the end of the base 11 with the cocked bow 12 and the wire hook 15 but opposite the end of the base 11 with the bait pedal 13. The safety arm 5 of the safety device 6 is positioned directly above the cocked bow 12. The screw attachment of the safety device is anchored to the base 11 such that the lever 4 used to reposition the safety arm 5 is located outside the swing path of the bow 12. Ideally, the threads of the screw attachment for the safety device 6 will penetrate the entire base 11 until the collar of the screw attachment approximately contacts the top of the base 11 of the mousetrap 10.

The bow 12 is attached to or overlapping a coil spring 16. The coil spring 16 and bow 12 are centrally attached to the base 11. The bow 12 can be held in place in a cocked position with the use of a locking bar 14 attached on one end to the wire hook 15 and on the other end to a v-shaped lip on the bait pedal 13. The front of the bait pedal 13 next to the coil spring 16 is anchored to the base 11 in a manner that permits the bait pedal 13 to rotate upward toward the cocked bow 12.

With a conventional spring-loaded mouse trap, the user places bait inside or on a bait pedal and then pulls back the bow and holds it down with a thumb while engaging the locking bar over the cocked bow and under the V-shaped lip of the bait pedal with the other hand. However, if a user's thumb slips while setting the locking bar, the bow will violently swing forward potentially harming the user. A manufacturer or user can install Safety For Mouse Trap by simply screwing the threads of the screw attachment into the appropriate location on the base of a mousetrap until the collar makes contact with the base. The safety arm is positioned directly over the bow of the mousetrap and the lever is located outside the swing path of the bow and can be used to move the safety arm out of position to allow the bow to operate once an operator loads the bait pedal.

Safety For Mouse Trap can be shipped already installed on a mousetrap with the bow already spring loaded and the bait pedal scent baited. The user would simply position the mousetrap with the bait pedal nearest to a wall and then rotate the lever on the safety device to move the safety arm out of the swing path of the bow. If the spring-loaded bow has accidentally discharged during shipping it can be reset in the same manner as the conventional mousetrap with the safety arm in place to prevent any injuries should an accidental discharge occur.

It should be understood that the safety device of the current invention could be employed on a variety of spring-loaded animal traps. Any device that has a cocked striking arm that can be caught by a safety arm when inadvertently fired can utilize the safety device of the current invention.

The materials utilized for Safety For Mouse Trap can vary widely but will likely include plastic and metal. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

Safety For Mouse Trap will be offered in a variety of sizes and colors. It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A safety device comprising:
(a) a screw attachment having a plurality of threads;
(b) a lever located on the screw attachment; and
(c) a safety arm located on the screw attachment;

2. The safety device of claim 1 wherein the plurality of threads is made of metal.

3. The safety device of claim 1 further comprising
a collar located on the screw attachment above the plurality of threads and below the safety arm and the lever.

4. The safety device of claim 3 wherein the plurality of threads extend from approximately the bottom of the screw attachment to the collar.

5. The safety device of claim 3 wherein the distance from the bottom of the screw attachment to the collar is approximately the same as the thickness of a base for a conventional mousetrap.

6. The safety device of claim 3 wherein the collar is approximately circular with a diameter of approximately one-half of an inch.

7. The safety device of claim 1 wherein the safety arm is angled approximately ninety degrees apart from the lever in approximately the same horizontal plane.

8. The safety device of claim 1 wherein the safety arm has a curved end.

9. A safety device comprising:
(a) a plurality of threads on the bottom of a screw attachment;
(b) a lever located on the top of the screw attachment;
(c) a safety arm with a curved end located on the top of the screw attachment and angled approximately ninety degrees apart from the lever in approximately the same horizontal plane; and
(d) a collar located on the screw attachment above the plurality of threads but below the lever and the safety arm wherein the plurality of threads extend from approximately the bottom of the screw attachment to the collar.

10. The device of claim 9 wherein the plurality of threads is made of metal.
